(19) United States
(12) Patent Application Publication
(10) Pub. No.: US 2009/0146414 A1
(43) Pub. Date: Jun. 11, 2009

(54) Method and system for joining pipeline components

(76) Inventors: Yuval Golan, New York, NY (US); Avraham Zakai, New York, NY (US)

Correspondence Address: YUVAL GOLAN, PO BOX 29746, TEL AVIV, 61297, IL

(21) Appl. No.: 12/001,189

(22) Filed: Dec. 11, 2007

(51) Int. Cl. F16L 47/02

(52) U.S. Cl. 285/21.3

(57) ABSTRACT

Pipes and pipeline components made of plastic or PVC, which are designed to be assembled into pipelines used to convey water in structures, and which have one bore located on the side, near each end of the pipeline components. After assembling the pipeline in the designated wall, the pipes and pipeline components are glued together by injecting liquid acetone into the bores, causing the pipes and pipeline components to adhere to one another and to become sealed.

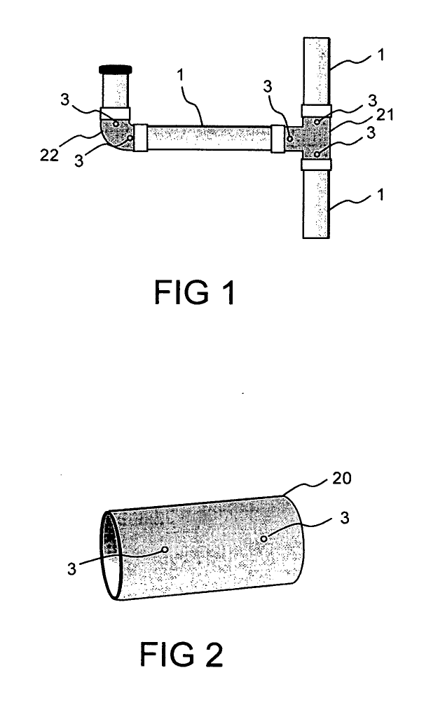

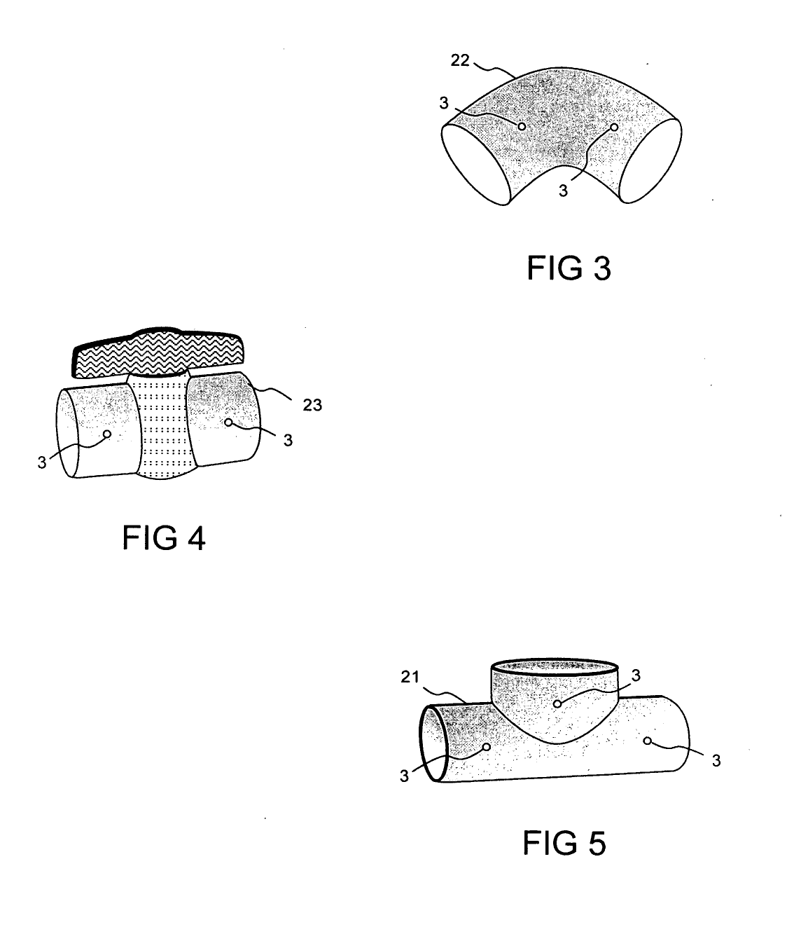

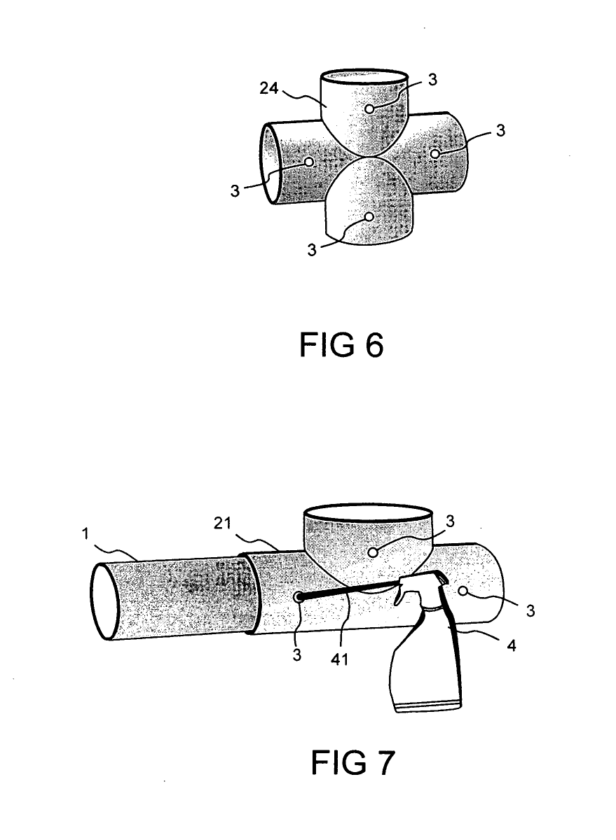

### TECHNICAL FIELD

The present invention deals with pipelines, pipes and pipeline components used to convey fluids, as well as a method for joining and sealing pipes and pipe segments to each other.

### BACKGROUND ART

Most structures throughout the world are equipped with pipe systems or pipelines used to convey fluids, mainly water. Such pipelines are customarily concealed in the structure's walls, floors and ceilings. Pipelines primarily include pipes, as well as components and accessories that make up the entire pipeline, such as couplings, elbows, valves, fittings and other parts and accessories that are used to join pipes and pipeline parts (hereinafter referred to as “pipeline components”).

For many years it was customary to use pipes and pipeline components (such as couplings, elbows, valves, etc.) that were made of metal and were joined to one another by screwing action. In recent years, it has become customary to use pipes and pipeline components that are made of plastic, mainly PVC. Such PVC pipes and pipeline components are joined to one another using an adhesive referred to in professional jargon as “PVC cement”.

When assembling PVC pipelines in structures, and particularly pipelines intended for the conveyance of water in residential homes, pipelines are usually assembled in stages, as follows:

(a) Pipes are cut according to required lengths;

(b) The pipeline is assembled in the wall (open or exposed wall during the construction of the structure or renovation), but without gluing the part of the pipeline to one another;

(c) After verifying correct dimensions of the pipeline, the pipeline is disassembled from the wall in order to prepare it for gluing;

(d) The pipes and pipeline components are glued to each other according to the order of components in the planned pipeline structure. Gluing is executed by applying PVC cement to the internal part of each relevant pipeline component and to the external part of the pipe that is to be glued to the said component (for instance, a coupling or elbow). After applying PVC cement, the end of the pipe is inserted into the said pipeline component, and after the PVC cement dries, the pipeline is glued, joined and sealed.

(e) After gluing of any number of pipeline components, it is customary to glue the end of this group of glued components to the relevant pipe already fixed in the wall, and so on and so forth, until the entire pipeline is assembled and glued in the wall or floor or other designated place.

Pipes and pipeline components, as they currently exist and the method of their assembly and gluing leads to a considerable waste of time. First, the pipeline is assembled in the designated wall twice. Once in order to verify the dimensions, and a second time, after gluing the pipeline, it is re-assembled in the designated wall. Second, after gluing the pipes and pipeline components to each other, the dimensions may change, since the gluing of the pipes to the pipeline connections slightly changes the connection point of the components, and the accumulation of these changes causes the pipeline to deviate from its designated location and from the location it was in during the first assembly prior to gluing.

The present invention significantly streamlines and reduces the cost of gluing and assembling the pipeline.

### THE INVENTION

### Numbers in Parentheses Refer to Numbers in Drawing

The present invention deals with pipelines that include pipes and pipeline components, and presents a method and a means of joining together pipes and pipeline components.

The invention, subject of the present patent application, deals with pipes and pipeline components that include bores, as depicted in the drawings attached to the application. Specifically, the invention deals with pipes and pipeline components whereby the side of each such pipe and pipeline component has a bore located at each end. Bores are preferably located 2 to 4 centimeters from each end of the component. Specifically, the bore should be located at about half the distance between the end of the component and its middle point. The desired diameter of the bores is about 1 to 2 mm., although they may be larger or smaller.

The invention deals with coupling (20) type components that include one or more bores (3), preferably at each end of the coupling, as depicted, for instance, in Drawing No. 2.

The invention deals with elbow (22) type components that include one or more bores (3), preferably at each end of the elbow, as depicted, for instance, in Drawing No. 3.

The invention deals with valve (23) type components that include one or more bores (3), preferably at each end of the valve, as depicted, for instance, in Drawing No. 4.

The invention deals with T-connector (21) type components that include one or more bores (3), preferably at each end of the connector, as depicted, for instance, in Drawing No. 5.

The invention deals with cross (24) type components that include one or more bores (3), preferably at each end of the cross, as depicted, for instance, in Drawing No. 6.

The invention refers to pipes that include one or more bores, preferably at each of their ends.

After assembling the pipeline in the designated wall, liquid acetone is injected into the bores, causing adhesion and sealing of the pipes and pipeline components. Thus, the need to disassemble the pipeline, glue it together using PVC cement and re-assemble it in the designated wall is avoided.

Drawing No. 7 depicts, for example, a T-connector (21) with three bores (3), one end of which is joined to a pipe (1). Also depicted is a spraying device (4) used to inject liquid acetone through the straw (41) directly into the left-hand bore (3), thus, effectively, sealing and gluing the pipe (1) to the connector (21).

Drawing No. 1 depicts, for instance, a pipeline composed of three pipes (1) that are connected to the three ends to a T-connector (21) that has three bores (3). The horizontal pipe (1) is connected to an elbow (22) with two bores (3), one at each end.

### DESCRIPTION OF THE DRAWINGS

The drawings attached to the application are not intended to limit the scope of the invention and the possible ways of its application. The drawings are intended only to illustrate the invention and constitute only one of many possible ways of its application.

The drawings attached to the present patent application are described and detailed above.

What is claimed is:

1. Pipes and pipeline components made of plastic or PVC, which are designed to be assembled into pipelines used to convey fluids in structures, and which have one or more bores located on the side of the pipe or pipeline component near each end of the pipe or pipeline component.

2. A method for joining together PVC or plastic pipes and pipeline components designed to be assembled into a pipeline used to convey fluids in structures. The method includes the use of pipeline components with one or more bores at each of their ends and the use of liquid acetone that is injected into the bores after the pipeline is assembled, causing the pipes and pipeline components to adhere to one another and to become sealed.
